(19) United States
(12) Patent Application Publication
(10) Pub. No.: US 2024/0311737 A1
(43) Pub. Date: Sep. 19, 2024

(54) TARGET ZONES FOR PREDICTIVE DATA FEATURES

(71) Applicant: State Farm Mutual Automobile Insurance Company, Bloomington, IL (US)

(72) Inventors: Nicholas Flannery, Atlanta, GA (US); Joshua Thomas Rohlfs, Lincoln, IL (US); Thomas Willers, Mesa, AZ (US); Jeffery D. Arseneau, Rossville, IL (US); Vincent M. Hummel, Roanoke, IL (US); Steven Michaels, Sandy Springs, GA (US)

(21) Appl. No.: 18/601,268

(22) Filed: Mar. 11, 2024

Related U.S. Application Data
(60) Provisional application No. 63/490,975, filed on Mar. 17, 2023.

(51) Int. Cl. G06Q 10/0639

(52) U.S. Cl. CPC G06Q 10/06393

(57) ABSTRACT

Training of a machine learning model can indicate data features within operational data, customer data, and/or worker data that are most predictive of outcome scores, such as customer satisfaction scores, associated with performance of instances of a process by an entity. The training of the machine learning model can also indicate target zones, associated with values of the identified predictive data features, that are associated with outcome scores within a target range. Process data, associated with a set of instances of the process, can be analyzed to identify instances of the process that associated with values of the predictive data features that are, or are not, within the target zones.

### RELATED APPLICATIONS

This U.S. patent application claims priority to provisional U.S. Patent Application No. 63/490,975, entitled “TARGET ZONES FOR PREDICTIVE DATA FEATURES,” filed on Mar. 17, 2023, the entirety of which is incorporated herein by reference.

### TECHNICAL FIELD

The present disclosure relates to identifying predictive data features that impact outcome scores associated with processes, and more particularly to determining target zones for the predictive data features.

### BACKGROUND

In various situations, processes performed by an entity may be associated with corresponding outcome scores. As an example, when an insurance company processes an insurance claim associated with a customer, the insurance company may request that the customer fill out a customer satisfaction survey associated with the insurance claim. The customer's answers to the customer satisfaction survey may indicate an outcome score associated with the processing of the insurance claim, such as a score that indicates whether the customer was satisfied or dissatisfied with how the insurance company processed the insurance claim.

However, although the customer satisfaction survey may indicate whether the customer was, or was not, satisfied with how the insurance company processed the insurance claim overall in this example, it may be unclear which factors associated with the processing of the insurance claim contributed to the customer's satisfaction level. For instance, if a customer's responses to a customer satisfaction survey indicate that the customer was relatively dissatisfied with how the insurance company processed an insurance claim, it may be unclear whether the customer's dissatisfaction was driven by the length of time it took the insurance company to process the insurance claim, by experiences during interactions between the customer and workers associated with the insurance company, and/or by other factors. Similarly, outcome scores associated with other types of processes performed by an entity may not identify which factors associated with the processes contributed to those outcome scores.

Moreover, even if factors associated with processes that may impact corresponding outcome scores can be identified, it may nevertheless be unclear which particular values associated with those factors impact the outcome scores. For instance, although overall claim processing times may impact customer satisfaction levels associated with the processing of insurance claims, it may be unclear which lengths of time may be likely to lead to low customer satisfaction levels and which lengths of time may be likely to lead to higher customer satisfaction levels.

The example systems and methods described herein may be directed toward mitigating or overcoming one or more of the deficiencies described above.

### SUMMARY

Described herein are systems and methods for determining data features that are predictive of outcome scores associated with processes, and for determining target zones indicating values of the predictive data features that are likeliest to be associated with outcome scores that are within a target range. The predictive data features can be identified from disparate data sources, including operational data associated with the processes, customer data about customers associated with the processes, worker data about workers who performed the processes, and/or other data. For example, the worker data can include worker satisfaction scores, such that values of worker satisfaction scores that may impact overall outcome scores can be identified. The predictive data features and corresponding target zones can be identified based on training of a machine learning model. Identified predictive data features, and identified target zones that correspond to the identified predictive data features, can be used to evaluate data associated with other instances of a process, for instance to determine whether values associated with the instances of the process are, or are not, within target zones that may be likeliest to be associated with outcome scores within a target range.

According to a first aspect, a computer-implemented method includes generating, by a computing system, and based on data retrieved from a plurality of data sources, a training data set. The training data set includes process data associated with performance of instances of a process. The training data set also includes outcome scores associated with the instances of the process. The computer-implemented method also includes training, by the computing system, and based on the training data set, a machine learning model to identify predictive data features, indicated by the process data, that are predictive of the outcome scores. The computer-implemented method further includes determining, by the computing system, target zones associated with the predictive data features, wherein the target zones indicate values of the predictive data features that are associated with a target range of the outcome scores.

According to a second aspect, a computing system includes one or more processors and memory. The memory stores computer-executable instructions. The computer-executable instructions, when executed by the one or more processors, cause the one or more processors to generate a training data set. The training data set includes process data associated with performance of instances of a process. The training data set also includes outcome scores associated with the instances of the process. The computer-executable instructions, when executed by the one or more processors, additionally cause the one or more processors to train a machine learning model, based on the training data set, to identify predictive data features, indicated by the processing data, that are predictive of the outcome scores. The computer-executable instructions, when executed by the one or more processors, further cause the one or more processors to determine target zones associated with the predictive data features, wherein the target zones indicate values of the predictive data features that are associated with a target range of the outcome scores.

According to a third aspect, one or more non-transitory computer-readable media store computer-executable instructions. The one or more non-transitory computer-readable media store computer-executable instructions, when executed by one or more processors of a computing system, cause the computing system to generate a training data set. The training data set includes first process data associated with performance of historical instances of a process. The training data set also includes outcome scores associated with the historical instances of the process. The computer-executable instructions additionally cause the computing system to train a machine learning model, based on the training data set, to identify predictive data features, indicated by the first process data, that are predictive of the outcome scores. The computer-executable instructions also cause the computing system to determine target zones associated with the predictive data features. The target zones indicate values of the predictive data features that are associated with a target range of the outcome scores. The computer-executable instructions further cause the computing system to identify instances of the predictive data features within second process data associated with performance of second instances of the process. The computer-executable instructions additionally cause the computing system to determine whether the instances of the predictive data features are associated with second values that are within the target zones. The computer-executable instructions also cause the computing system to generate insight output based on determining whether the instances of the predictive data features are associated with the second values that are within the target zones.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a system configured to identify predictive data features that impact outcome scores associated with instances of a process, as well as to determine target zones associated with the identified predictive data features.

FIG. 2 shows an example accumulated local effects plot that can be generated based on the training of the machine learning model and/or a data feature identified during the training of the machine learning model.

FIG. 3 shows a flowchart illustrating an example method that can be used to train the machine learning model and determine predictive data features and corresponding target zones.

FIG. 4 shows a flowchart illustrating an example method that can be used to generate insight output associated with process data, based on predictive data features and corresponding target zones determined via training of a machine learning model.

FIG. 5 shows an example system architecture for a computing system that can execute one or more elements of the system described herein.

### DETAILED DESCRIPTION

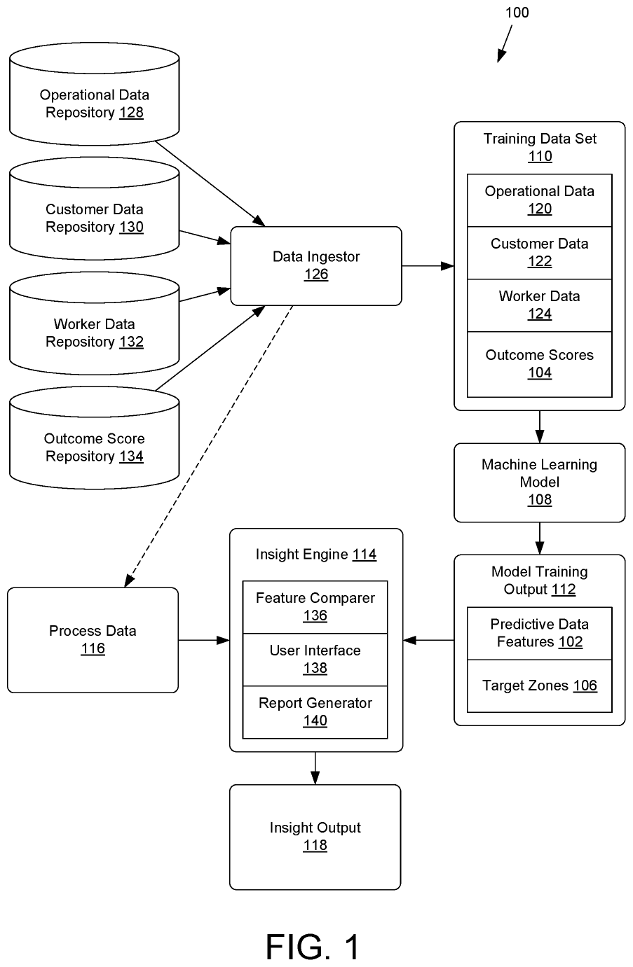

FIG. 1 shows an example of a system 100 configured to identify predictive data features 102 that impact outcome scores 104 associated with instances of a process performed by an entity. In some examples, the process may be processing of one or more insurance claims by an insurance company. In other examples, the process may be handling of customer contacts via a call center or other contact center. In still other examples, the process may involve interactions between customers and workers and/or agents associated with an entity, may involve processing of customer information by workers and/or agents, or may be another type of process performed by a business or other entity. As described further below, the outcome scores 104 may be scores associated with performance of instances of the process by the entity, such as satisfaction scores, retention scores, or other types of scores associated with workers, customers, agents, and/or individuals or elements. The system 100 can also be configured to determine target zones 106 associated with identified predictive data features 102. The target zones 106 may indicate values of one or more predictive data features 102 that may be more likely to be associated with higher outcome scores 104 than lower outcome scores 104.

The system 100 can include a machine learning model 108 that is trained on a training data set 110. The training data set 110 can include historical data associated with historical instances of the process that have previously been performed.

As a non-limiting example, the process may be insurance claim processing by an insurance company, and the outcome scores 104 may be customer satisfaction scores indicating whether customers associated with insurance claims are satisfied with the processing of the insurance claims. In this example, the training data set 110 can include historical customer satisfaction scores associated with a set of previously-processed insurance claims. For instance, the training data set 110 may include data about insurance claims processed by the insurance company over the past ten quarters, or over any other period of time. The machine learning model 108 can thus be trained, based on the training data set 110, to determine predictive data features 102, indicated by the training data set 110, that are predictive of customer satisfaction scores associated with corresponding insurance claims.

The training of the machine learning model 108, and/or analysis of the predictive data features 102 identified during the training of the machine learning model 108, can also determine target zones 106 associated with one or more of the predictive data features 102. The target zones 106 may indicate values, associated with one or more predictive data features 102, that are likely to be associated with outcome scores 104 in a target range. For example, the target zones 106 may indicate values, of predictive data features 102, that are likely to be associated with outcome scores 104 that exceed one or more target thresholds.

Model training output 112 generated during and/or based on the training of the machine learning model 108, including indications of the predictive data features 102 and/or corresponding target zones 106, can be used by an insight engine 114. The insight engine 114 can use the predictive data features 102 and the target zones 106, identified based on the model training output 112, to analyze process data 116 associated with historical and/or current instances of the process. For example, if the process is insurance claim processing by an insurance company, the process data 116 may be associated with insurance claims that are being, and/or have been, processed by the insurance company. The insight engine 114 can accordingly identify instances of the predictive data features 102 within process data 116 associated with insurance claims that are currently being processed and/or that have been processed.

The insight engine 114 can also determine whether values of the predictive data features 102, within process data 116 associated with instances of the process, are inside or outside corresponding target zones 106. As an example, if the process is insurance claim processing by an insurance company, the insight engine 114 can determine whether values of identified predictive data features 102, within process data 116 associated with insurance claims that are currently being processed, are within corresponding target zones 106. The insight engine 114 can accordingly generate and/or display insight output 118 that indicates whether individual instances of the process, and/or groups of instances of the process, have predictive data features 102 with values that are inside or outside corresponding target zones 106.

As discussed above, in some examples the training data set 110 and the process data 116 can be associated with insurance claims submitted to, and/or processed by, an insurance company. The insurance claims can be automobile insurance claims, life insurance claims, home insurance claims, and/or other types of insurance claims. When an insurance claim is submitted to the insurance company, one or more workers associated with the insurance company can perform actions to process the insurance claim. For instance, one or more claim handlers or other workers can process an automobile insurance claim by determining whether associated parties have insurance coverage, determining how much insurance coverage the parties have, determining which party is at fault, determining if multiple parties are at fault in a comparative negligence situation, determining amounts to be paid to one or more parties, negotiating with other insurance companies during subrogation, and/or taking other actions to at least partially process and/or resolve the automobile insurance claim.

In some of these examples, a worker associated with the insurance company can be a claim handler, representative, or other worker who is directly employed by the insurance company. In other examples, a worker associated with the insurance company can be a contractor, agent, or other party that is independent and/or not directly employed by the insurance company, but who is tasked to perform one or more operations to process insurance claims for the insurance company.

In other examples, workers may be other types of workers associated with an entity who have other roles or duties, and/or who perform operations associated with other types of processes. As an example, if the process is associated with interactions between customers and a contact center, a worker may be an agent or representative who works at the contact center and who interacts with customers via phone calls, video calls, text exchanges, and/or other types of communications.

The term “customers,” as used herein, can refer to parties who initiate, or are otherwise associated with, instances of a process performed by an entity. For example, if the process is insurance claim processing by an insurance company, “customers” may be parties who submit insurance claims to the insurance company, and/or that may receive payments associated with such insurance claims. In some of these examples, “customers” can be policyholders that have insurance policies provided by the insurance company, and may submit associated insurance claims to the insurance company and/or receive corresponding payments associated with the insurance claims. However, in other examples, “customers” can be third-party claimants or other entities that submit insurance claims to the insurance company and/or may receive corresponding payments associated with the insurance claims. In examples associated with other types of processes, “customers” may be callers or other parties who contact a contact center, parties who interact with workers during instances of a process, parties who are impacted by outcomes of instances of a process, or other types of users, individuals, groups, or parties who may be impacted by how instances of the process are performed and/or the outcomes of the instances of the process.

The training data set 110 can include historical process data, such as operational data 120, customer data 122, and/or worker data 124, associated with historical instances of a process performed by an entity. The training data set 110 can also include outcome scores 104 associated with the historical instances of the process.

As an example, if the process is insurance claim processing by an insurance company, the training data set 110 can include operational data 120, customer data 122, and/or worker data 124 associated with insurance claims that have been processed previously by the insurance company. The training data set 110 can also include outcome scores 104, such as customer satisfaction scores or other types of outcome scores 104, associated with the previously-processed insurance claims.

The machine learning model 108 can be trained based on the training data set 110 to identify predictive data features 102, indicated by one or more of the operational data 120, the customer data 122, and the worker data 124, that are predictive of corresponding outcome scores 104 indicated by the training data set 110. The predictive data features 102, identified based on the training of the machine learning model 108, can be key drivers of the outcome scores 104. For example, the predictive data features 102 can be particular types of data within the operational data 120, the customer data 122, and/or the worker data 124 that, according to the training of the machine learning model 108, are most predictive of, and/or have the most impact on, the outcome scores 104. Training of the machine learning model 108 is discussed further below.

The operational data 120 can include information about how instances of the process were performed. For example, the operation data 120 may include information about how long it took to perform instances of the process, information about interactions with customers and workers during performance of instances of the process, information about actions taken by workers during performance of instances of the process, and/or other information.

As an example, if the process is insurance claim processing by an insurance company, the operational data 120 may indicate claim processing cycle times associated with insurance claims. Claim processing cycles times can be measured as lengths of time between when the insurance claims are initially reported or submitted to the insurance company, and when processing of the insurance claims are complete and/or corresponding payments are made. As a non-limiting example, if a payment is made to a customer associated with an insurance claim thirty-five days after the insurance claim was submitted, the claim processing cycle time associated with that insurance claim can be thirty-five days.

As another example, the operational data 120 can also include information about communications between customers and the insurance company during processing of insurance claims. For instance, the operational data 120 can indicate how many times, and/or how frequently, a customer associated with a particular insurance claim called the insurance company to check on the status of the insurance claim during processing of the insurance claim. As another example, the operational data 120 can indicate how many, and/or how frequently, electronic messages or other communications were sent to, and/or received from, customers associated with insurance claims during processing of the insurance claims.

As yet another example, the operational data 120 can also include any other information about how, and/or how efficiently, previous insurance claims were processed. For instance, the operational data 120 can indicate how many notes were entered by workers into files associated with an insurance claim and/or a corresponding customer during processing of the insurance claim. The operational data 120 can also, or alternately, indicate how many workers worked on individual insurance claims, which workers worked on individual insurance claims, whether and/or how frequently insurance claims were transferred between workers during processing of the insurance claims, and/or other information about how the insurance claims were processed.

The operational data 120 may include similar and/or different types of information for other types of processes. For example, if the process is handling of customer contacts by a contact center, the operational data 120 may indicate how many times a customer contacted the contact center about an issue, which workers at the contact center fielded the customer contacts, how long it took to resolve the customer's issue, and/or other information.

The customer data 122 can include information about customers associated with instances of the process. For example, the customer data 122 can indicate ages, genders, residential locations, and/or other demographic information about individual customers. As another example, if the process is insurance claim processing by an insurance company, the customer data 122 can indicate whether customers are actual customers of the insurance company, are third-party claimants, or are associated with any other entities. The customer data 122 associated with customers can include, or be linked with, corresponding outcome scores 104 provided by the customers, such as customer satisfaction scores or customer retention scores as discussed further below.

The worker data 124 can include information about workers that worked on instances of the process. The worker data 124 can, for example, indicate worker names and/or identification numbers, tenure or experience levels of the workers, departments or groups in which the workers work, human resources (HR) data associated with the workers, and/or other information. As another example, if the process is insurance claim processing, the worker data 124 and/or the operational data 120 can indicate which workers worked on which insurance claims, numbers of hours that individual workers worked on individual insurance claims, numbers of insurance claims assigned concurrently to individual workers on average and/or at particular times, and/or other information. The worker data 124 and/or the operational data 120 can also indicate similar types of information associated with other types of processes.

The worker data 124 can also indicate worker satisfaction scores associated with workers. The worker satisfaction scores can indicate subjective feelings or opinions of the workers. The worker satisfaction scores may be based on answers to worker surveys. For example, workers may periodically or occasionally fill out surveys, provided by the entity, that ask the workers for subjective input about job satisfaction levels, stress levels, workload levels, career progression satisfaction, commitment levels to the entity, turnover likelihoods, and/or other types of data or metrics. Worker answers to such surveys can be used to determine corresponding worker satisfaction scores for corresponding workers, and/or to track changes in the worker satisfaction scores over time.

As an example, a first worker who indicates via a survey that the first worker has a relatively low stress level, is relatively satisfied with the worker's career progression, and/or does not feel overworked may be associated with a relatively high worker satisfaction score. However, a second worker who indicates via a survey that the second worker has a relatively high stress level, is relatively dissatisfied with the worker's career progression, and/or does feel overworked may be associated with a relatively low worker satisfaction score.

Worker satisfaction scores in the worker data 124 may also, or alternately, be based on sentiment analysis of calls or other communications between the workers and customers. For example, a recording and/or transcript of a call between a worker and a customer can be analyzed using audio analysis systems, natural language processing systems, and/or other systems to determine words used by the worker during the call, emotions expressed by the worker during the call, and/or other types of sentiment information. For instance, sentiment analysis may indicate whether a worker was calm or frustrated during a particular call. An indication that the worker was frustrated during a call may be associated with a relatively low worker satisfaction score, while an indication that the worker was calm during a call may be associated with a relatively high worker satisfaction score.

In some examples, worker satisfaction scores can be generated as numerical values, letter grades, or other values on a corresponding scale, for instance based on weights associated with different answers to worker survey questions. In other examples, worker satisfaction scores can be selected from predetermined tiers, such as a highly satisfied tier, a moderately satisfied tier, or a dissatisfied tier.

As discussed above, in some examples the operational data 120 may indicate worker identifiers associated with one or more workers who worked on a particular instance of the process. For example, if the process is insurance claim processing, the operational data 120 may indicate which workers helped process a particular insurance claim. Accordingly, worker identifiers indicated by the operational data 120 can be used to identify corresponding worker data 124, such as worker satisfaction scores and/or other information, associated with the workers who worked on particular instances of the process. In other examples, the worker data 124 may directly indicate which workers worked on particular instances of the process.

The outcome scores 104 may be scores that are associated with instances of the process. In some examples, the outcome scores 104 may be customer satisfaction scores that indicate how satisfied individual customers were with how the entity performed instances of the process, and/or how satisfied individual customers were with interactions with the entity during the instances of the process.

As an example, if the process is insurance claim processing by an insurance company, the outcome scores 104 may be customer satisfaction scores that indicate how satisfied individual customers were with the processing of insurance claims by the insurance company, and/or how satisfied individual customers were with interactions with the insurance company during processing of the insurance claims. The customer satisfaction scores can indicate subjective feelings or opinions of the customers. In some examples, the customer satisfaction scores can be referred to as “claim journey scores,” such as scores indicating how satisfied customers were with their experiences overall during “journeys” of insurance claims from initial submissions to final resolutions and/or payments.

In some examples, the outcome scores 104, such as customer satisfaction scores, may be based on answers to customer surveys. Such customer surveys can be provided to customers following completion of instances of the process. For instance, if the process is insurance claim processing by an insurance company, the insurance company may request that customers associated with insurance claims fill out a customer survey after payments have been made to the customers and/or other parties in association with the insurance claims. Accordingly, the customers can optionally provide answers to questions in the survey, and/or provide satisfaction scores in one or more categories, indicating how satisfied the customers were with the overall processing of the insurance claims by the insurance company between initial submission of the insurance claims and final resolution and/or payment associated with the insurance claims.

Outcome scores 104 may also, or alternately, be based on sentiment analysis of calls or other communications between the customers and workers of the insurance company. For example, similar to the sentiment analysis associated with workers discussed above, a recording and/or transcript of a call between a worker and a customer can be analyzed using audio analysis systems, natural language processing systems, and/or other systems to determine words used by the customer during the call, emotions expressed by the customer during the call, and/or other types of sentiment information. For instance, sentiment analysis may indicate whether a customer was calm or frustrated during a particular call. An indication that the customer was frustrated during a call may be associated with a relatively low customer satisfaction score, while an indication that the customer was calm during a call may be associated with a relatively high customer satisfaction score.

Although the outcome scores 104 may be customer satisfaction scores as discussed above, the outcome scores 104 may be other types of scores. For example, the outcome scores 104 may include customer retention scores that indicate how long customers associated with instances of the process remained customers of the entity following completion of those instances of the process. In other examples, the outcome scores 104 may be the worker satisfaction scores discussed above, may be worker retention scores indicating how long workers associated with instances of the process continued to be associated with the entity following completion of those instances of the process, may be satisfaction and/or retention scores associated with third party agents associated with instances of the process, and/or other types of scores associated with instances of the process.

In some examples, outcome scores 104 can be generated as numerical values, letter grades, or other values on a corresponding scale, for instance based on weights associated with different answers to survey questions by customers, workers, or other parties. In other examples, outcome scores 104 can be selected from predetermined tiers, such as a highly satisfied tier, a moderately satisfied tier, or a dissatisfied tier.

The system 100 can have, or be associated with, a data ingestor 126 that is configured to receive data from one or more sources, and to generate and/or pre-process the training data set 110 based on the data received from the one or more sources. For example, the data ingestor 126 may obtain the operational data 120 from an operational data repository 128, the customer data 122 from a customer data repository 130, the worker data 124 from a worker data repository 132, and/or the outcome scores 104 from an outcome score repository 134.

Different data sources, such as the operational data repository 128, the customer data repository 130, the worker data repository 132, and the outcome score repository 134, may be different databases or other data repositories. For example, the customer data repository 130 can include a database of customer information, such a database of information associated with policyholders associated with insurance claims, while the worker data repository 132 can be an HR database that stores information about workers associated with the entity. Accordingly, the different data sources may store corresponding data using different database types, different data structures, different file types, and/or other different attributes. The different data sources may also be associated with different application programming interfaces (APIs), or other interfaces or access methods, through which data can be accessed or retrieved.

The data ingestor 126 can be configured to access and/or retrieve data from different data sources, such as the operational data repository 128, the customer data repository 130, the worker data repository 132, and/or the outcome score repository 134. For example, the data ingestor 126 can be configured to use different APIs, different database queries or query types, and/or other interfaces or access methods associated with the different data sources, to retrieve corresponding types of data from the different data sources.

The data ingestor 126 can also be configured to pre-process data received from one or more of the different data sources, such that the data ingestor 126 can generate the training data set 110 based on the pre-processed data. Pre-processing the data can include the data ingestor 126 analyzing different types of data to determine which data elements from different data sources are associated with the same instances of the process. The data ingestor 126 can accordingly generate the training data set 110 such that operational data 120, customer data 122, worker data 124, and outcome scores 104 associated with the same instances of the process are linked or are otherwise correlated within the training data set 110.

As a non-limiting example, if the process is insurance claim processing, the data ingestor 126 may obtain operational data 120, about previous processing of a set of insurance claims, from the operational data repository 128. The data ingestor 126 can determine that the operational data 120 indicates claim identification numbers associated with each of the insurance claims. The operational data 120 may also include identifiers of customers associated with each of the insurance claims, and/or identifiers of one or more workers who worked on processing each of the insurance claims. Based on the claim identification numbers indicated by the operational data 120, and/or corresponding customer identifiers and/or worker identifiers indicated by the operational data 120, the data ingestor 126 can also identify customer data 122 from the customer data repository 130 about the customers that are associated with the insurance claims, and/or identify worker data 124 from the worker data repository 132 about the workers that worked on the insurance claims. The data ingestor 126 can additionally identify outcome scores 104 associated with the insurance claims, such as customer satisfaction scores that were provided by the customers in association with the insurance claims, from the outcome score repository 134.

Accordingly, in this example, the data ingestor 126 can identify operational data 120, customer data 122, and/or worker data 124, and one of the outcome scores 104, that are associated with the same individual insurance claim, even though the different types of data may have been stored at, and retrieved from, different data sources. The data ingestor 126 can identify related operational data 120, customer data 122, and/or worker data 124, and outcome scores 104, associated with multiple individual insurance claims, and generate the training data set 110 such that related operational data 120, customer data 122, worker data 124, and/or outcome scores 104 are linked based on the same claim identifier or other connection. The data ingestor 126 may also perform operations to change or convert file types, data formats, and/or other attributes of the operational data 120, customer data 122, worker data 124, and/or outcome scores 104, such that different types of information in the training data set 110 are expressed in a consistent or standardized format that can be consumed and used by the machine learning model 108 and/or other elements of the system 100.

As discussed above, the machine learning model 108 can be trained based on the training data set 110, to determine which attributes within the operational data 120, customer data 122, and/or worker data 124 associated with previous instances of the process are predictive data features 102 that are key drivers of the known outcome scores 104 associated with those previous instances of the process. The training of the machine learning model 108, and/or analysis of information associated with the predictive data features 102 identified via the training of the machine learning model 108, can also indicate target zones 106 associated with the identified predictive data features 102, as described further below.

In some examples, the machine learning model 108 may be based on Random Forest algorithms. In other examples, the machine learning model 108 may be based on convolutional neural networks, recurrent neural networks, other types of neural networks, nearest-neighbor algorithms, regression analysis, deep learning algorithms, Gradient Boosted Machines (GBMs), decision trees, support-vector networks, and/or other types of artificial intelligence or machine learning frameworks.

The machine learning model 108 can be trained using a supervised machine learning approach. For example, during supervised machine learning, customer satisfaction scores or other outcome scores 104, associated with previous instances of the process, can be used as targets for the training of the machine learning model 108. The training of the machine learning model 108 can evaluate various data points within the training data set 110, such as within the operational data 120, the customer data 122, and/or the worker data 124, to determine which data points and/or corresponding types of data are predictive data features 102 that are most predictive of the target outcome scores 104.

Supervised learning algorithms can, for instance, determine weights for different data features and/or different combinations of data features from the training data set 110 that optimize prediction of the target outcome scores 104. As an example, machine learning algorithms can detect which combinations of data features in the training data set 110 are statistically most relevant to predicting the target outcome scores 104, and/or determine weights for different data features, and can thus prioritize and/or weight the data features in relative relation to each other.

The training of the machine learning model 108 can continue until the machine learning model 108 can use identified data features and/or corresponding weights to produce the target outcome scores 104 to at least a threshold degree of accurately, for instance based on instances of the data features within the training data set 110 and/or a separate test data set that was not used to train the machine learning model 108. For example, supervised learning algorithms can adjust which data features are considered, and/or adjust weights associated with the data features, until the machine learning model 108 can generate the target outcome scores 104 from the training data set 110 and/or a separate test data set to at least the threshold degree of accurately.

The training of the machine learning model 108 may determine which data features have the largest weights, and/or have weights that are above a threshold. The training of the machine learning model 108 can accordingly determine that those data features are the predictive data features 102 that are the most predictive of, and/or are likeliest to be key drivers of, the outcome scores 104. The training of the machine learning model 108 can accordingly identify those data features as being predictive data features 102. The predictive data features 102 identified during the training of the machine learning model 108 can be indicated in corresponding model training output 112.

Target zones 106 associated with the identified predictive data features 102 can also be determined via training of the machine learning model 108, and/or by other analysis of information associated with the predictive data features 102. The target zones 106 associated with the predictive data features 102 can be indicated in the model training output 112, or can be determined based on the model training output 112. Target zones 106 can be values, or ranges of values, of one or more predictive data features 102 that indicate whether corresponding outcome scores 104 are likely to be relatively high and/or in a target range of desirable outcome scores 104.

As a non-limiting example, the outcome scores 104 may be customer satisfaction scores associated with processing of insurance claims. The customer satisfaction scores may be expressed on a scale of one to ten, with a customer satisfaction score of ten indicating high customer satisfaction. A target range for the outcome scores 104 can be set at seven or higher, as outcome scores 104 of seven or higher may indicate that customers were relatively satisfied with how insurance claims were processed. Outcome scores 104 of seven or higher can accordingly be inside the target range for the outcome scores 104. However, outcome scores 104 of six or lower may indicate that customers were only moderately satisfied, or were dissatisfied, with how insurance claims were processed, and thus can be outside the target range for the outcome scores 104.

The target zones 106 can thus indicate values of one or more predictive data features 102 that are likeliest to indicate that corresponding outcome scores 104 are, or will be, relatively high and/or in a target range. As a non-limiting example, if the process is insurance claim processing, the training of the machine learning model 108 may indicate that when operational data 120 indicates that customers called in to check on the status of their insurance claims zero, one, or two times during processing of the insurance claims, corresponding customer satisfaction scores were, in general, relatively high and/or within a desired range. However, the training of the machine learning model 108 may also indicate that when operational data 120 indicates that customers called in to check on the status of their insurance claims three or more times, corresponding customer satisfaction scores were generally lower and/or outside the desired range. Accordingly, in this example, the training of the machine learning model 108 can indicate that on average there is a steep drop in customer satisfaction scores when customers call in three or more times during processing of insurance claims, relative to when customers call in two or fewer times. The training of the machine learning model 108 can thus indicate that a target zone, associated with a number of incoming calls, is two or fewer incoming calls.

As another non-limiting example, the training of the machine learning model 108 may indicate that when worker data 124 indicates that workers who are associated with worker satisfaction scores at or above 75% worked on insurance claims, corresponding customer satisfaction scores were above a target value. However, the training of the machine learning model 108 may also indicate that when worker data 124 indicates that when workers who are associated with worker satisfaction scores below 75% worked on insurance claims, corresponding customer satisfaction scores were below the target value. Accordingly, the training of the machine learning model 108 can indicate that a target zone for worker satisfaction scores is 75% and above.

In some examples, the target zones 106 can be determined based on accumulated local effects plots associated with the predictive data features 102 identified during training of the machine learning model 108. For instance, accumulated local effects plots can indicate outcome scores 104 that are associated with different values of one or more of the predictive data features 102. The accumulated local effects plots can also indicate values, and/or ranges of values, of one or more of the predictive data features 102 that are associated with outcome scores 104 that are above a target threshold or are within a target range, or are associated with significant changes in the outcome scores 104. The target zones 106 can indicate values of the predictive data features 102 that correspond with outcome scores 104 that are above the target threshold or are within the target range, or that are not associated with a significant drop or change in the outcome scores 104.

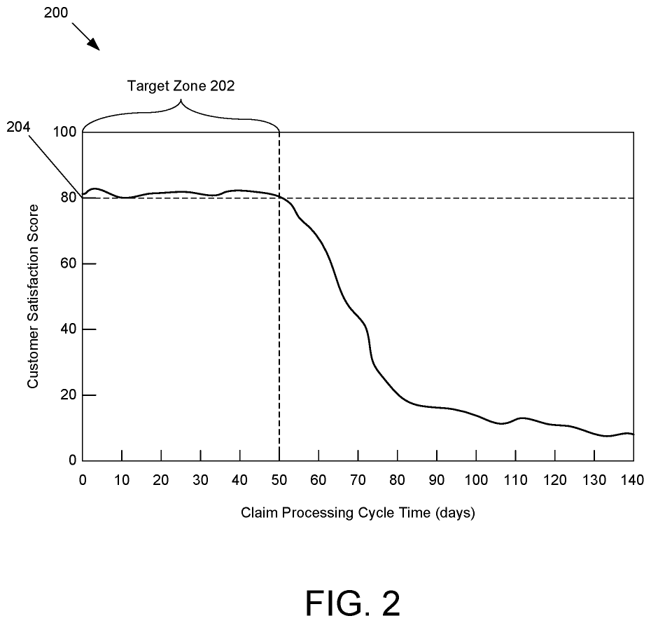

As a non-limiting example, FIG. 2 shows an example accumulated local effects plot 200 that can be generated based on the training of the machine learning model 108 and/or a predictive data feature identified during the training of the machine learning model 108. In the example shown in FIG. 2, the process can be insurance claim processing, and the example accumulated local effects plot 200 is associated with a claim processing cycle time data feature. The training of the machine learning model 108 may indicate that claim processing cycle time, indicating lengths of time between initial submissions of insurance claims and final resolution and/or payment associated with the insurance claims, is one of the predictive data features 102 that is most predictive of corresponding customer satisfaction scores. The customer satisfaction scores may be an example of outcome scores 104, as discussed above. The accumulated local effects plot 200 can indicate values, such as average and/or interpolated values, of customer satisfaction scores that are associated with different claim processing cycle times. As shown in FIG. 2, customer satisfaction scores can be relatively high when claim processing cycle times are 50 days or below, but the customer satisfaction scores drop sharply when the claim processing cycle times exceed 50 days. Accordingly, a target zone 202 associated with the claim processing cycle time data feature can be determined to be 50 days or fewer.

In some examples, one or more boundaries of a target zone can be identified by evaluating slopes of a corresponding accumulated local effects plot, and determining a value of a predictive data feature at which the slopes turn negative and/or are below a threshold slope value. For instance, in the example shown in FIG. 2, the 50-day mark can be a value of the claim processing cycle time at which the customer satisfaction scores begin to drop sharply and the slope of the accumulated local effects plot 200 goes below a threshold slope value. Accordingly, a boundary of the target zone 202 can be determined to a 50 day claim processing cycle time, and the target zone 202 associated with the claim processing cycle time predictive data feature can be a range of zero days to 50 days.

In other examples, boundaries of a target zone can be identified by evaluating an accumulated local effects plot, and determining values of a predictive data feature that meet or exceed a target customer satisfaction score or other target outcome score 104. For instance, in the example shown in FIG. 2, a target customer satisfaction score 204 can be a score of 80, on a scale of 0 to 100. As shown in the accumulated local effects plot 200, customer satisfaction scores can meet or exceed a score of 80 when claim processing cycle times are between zero and 50 days. Accordingly, the target zone 202 associated with the claim processing cycle time predictive data feature can be a range of zero days to 50 days.

The training of the machine learning model 108 may identify individual predictive data features 102 that have the highest impacts on corresponding outcome scores 104, as well as corresponding target zones 106, as discussed above. However, the training of the machine learning model 108 may also identify particular combinations of different predictive data features 102 that have the highest impacts on corresponding outcome scores 104. The training of the machine learning model 108 can also identify corresponding target zones 106 associated with such combinations of predictive data features 102. Target zones 106 associated with particular combinations of predictive data features 102 may be different than target zones 106 for the individual predictive data features 102 alone.

For instance, in an example discussed above, the training of the machine learning model 108 may determine that claim processing cycle times over 50 days are generally associated with customer satisfaction scores that are below a target customer satisfaction score 204. However, the training of the machine learning model 108 may also determine that if claim processing cycle times are between 50 and 70 days, customer satisfaction scores are nevertheless generally still above the target customer satisfaction score 204 if worker data 124 indicates that workers who worked on corresponding insurance claims had worker satisfaction scores above 80%, and if operational data 120 indicates that customers called in to check on the insurance claims no more than once. Accordingly, in this example, target zones 106 associated with this combination of predictive data features 102 may be associated with worker satisfaction scores above 80%, zero or one incoming calls, and a claim processing cycle times that is lower than 70 days.

As another example, the training of the machine learning model 108 may determine that if worker satisfaction scores associated with workers that processed insurance claims are above a certain threshold, claim processing cycle times are below a certain threshold, and fewer than a certain number of notes were entered into a file, corresponding customer satisfaction scores are above a target value regardless of the number of times customers call in during processing of the insurance claims. Accordingly, the training of the machine learning model 108 may determine one or more distinct target zones 106 that correspond with this combination of predictive data features 102.

Overall, the training of the machine learning model 108 may identify types of predictive data features 102, combinations of predictive data features 102, and/or corresponding target zones 106 that may otherwise be difficult or impossible to identify. For example, it may not be practical for a human analyst to evaluate and correlate a large set of data from disparate sources, such as the operational data repository 128, the customer data repository 130, the worker data repository 132, and/or the outcome score repository 134, to objectively determine which specific data features indicated by that large set of data are most predictive of outcome scores 104, and/or to objectively determine which values of those data features are likeliest to be predictive of desirable outcome scores 104. However, the machine learning model 108 may be trained to objectively identify predictive data features 102 and corresponding target zones 106 based on a training data set 110 that may be too large and/or include too many disparate types of data for a human analyst to practically evaluate.

The insight engine 114 can be configured to use the predictive data features 102 and corresponding target zones 106, determined based on the training of the machine learning model 108, to evaluate process data 116. The process data 116 can be associated with instances of the process that have been performed, and/or that are currently being performed by the entity. The process data 116 may be associated with a different set of instances of the process than the training data set 110. As an example, if the process is insurance claim processing, the process data 116 may include information about insurance claims that have been processed, and/or are currently being processed by the insurance company. In this example, although the training data set 110 can be associated with a historical set of insurance claims, the process data 116 can be associated with a different set of current and/or past insurance claims.

In some examples, the process data 116 can indicate one or more types of operational data 120, customer data 122, and/or worker data 124. However, the process data 116 may be associated with instances of a process that are not yet associated with outcome scores 104. For example, if the process is insurance claim processing, the process data 116 may be associated with insurance claims that are currently being processed and that are not yet associated with customer satisfaction scores or other types of outcome scores 104.

In some examples, the data ingestor 126 may retrieve data from the operational data repository 128, the customer data repository 130, and/or the worker data repository 132. The data ingestor 126 can use the retrieved data to identify data elements from the different data sources that are associated with the same instances of the process, and generate or provide corresponding process data 116 to the insight engine 114. For instance, the data ingestor 126 may pre-process retrieved data to identify and/or correlate data from different data sources that are associated with the same instances of the process. In other examples, the process data 116 can be provided to the insight engine 114 by any other data source, or be aggregated from one or more data sources by one or more other elements.

The insight engine 114 can have a feature comparer 136 that is configured to identify instances of the predictive data features 102 indicated by the process data 116. The feature comparer 136 can also determine whether values, indicated by the process data 116, of individual predictive data features 102 and/or combinations of predictive data features 102, are within corresponding target zones 106. The insight engine 114 can also have a user interface 138 and/or a report generator 140 that can be used to display or present insight output 118, such as metrics, reports, and/or alerts, associated with instances of the predictive data features 102 indicated by the process data 116. For example, the insight engine 114 can determine metrics, and/or output corresponding reports and/or alerts, about instances of the process for which the predictive data features 102 have values that are and/or are not within corresponding target zones 106, and/or that are at risk of moving outside corresponding target zones 106.

As a non-limiting example, if the process is insurance claim processing, the training of the machine learning model 108 may indicate that a number of times a customer calls in to check on the status of an insurance claim, during processing of the insurance claim, is a predictive data feature that has a high impact on corresponding customer satisfaction scores. The training of the machine learning model 108 may also indicate that a target zone for the number of times a customer calls in during processing of an insurance claim is two calls or fewer, because the training data set 110 indicates that customer satisfaction scores drop sharply if customers call in more than two times.

Accordingly, in this example, the feature comparer 136 of the insight engine 114 can use process data 116 about a set of previously-processed insurance claims to determine metrics about which, and/or how many, insurance claims in the set had two or fewer incoming customer calls and were thus within the target zone for incoming calls. The feature comparer 136 can similarly use the process data 116 to determine metrics about which, and/or how many, insurance claims in the set had three or more incoming customer calls and were thus outside the target zone for incoming calls.

The feature comparer 136 may also use process data 116 about a set of current instances of the process to determine similar metrics about which, and/or how many, of the current instances of the process have values of one or more predictive data features 102 that meet and/or do not meet target zones 106. The feature comparer 136 can additionally use the process data 116 to identify current instances of the process that have values of predictive data features 102 that are at risk of going outside corresponding target zones 106.

As an example, if the process is insurance claim processing and a target zone for incoming calls is two or fewer, the feature comparer 136 may use process data 116 to identify insurance claims that are currently being processed and that have had two incoming calls, and are thus at the upper boundary of the target zone for incoming calls. If customers associated with these insurance claims call in one additional time, the numbers of incoming calls associated with the insurance claims would increase to three and move outside the target zone. Accordingly, the insight engine 114 may flag these insurance claims in reports generated by the report generator 140, and/or display corresponding alerts via the user interface 138, such that action can be taken to expedite processing of the insurance claims and reduce the likelihoods of the customers calling in for third times that may lead to a drop in corresponding customer satisfaction levels.

As another example, if the process is insurance claim processing and a target zone for claim processing cycle times is 50 days, the feature comparer 136 may identify current insurance claims that have been in process for 50 or more days, or that are not anticipated to be completed by the 50 day mark. Accordingly, the identified insurance claims can be prioritized or reassigned to workers to expedite completion of the processing of the insurance claims. In some examples, worker data 124 can be used to identify which workers have small backlogs and/or are skilled at quickly processing similar insurance claims. The insurance claims can be reassigned to such workers to increase the likelihood of the insurance claims being processed by the 50 day mark. Alternatively, or in addition, workers can proactively reach out to customers to explain why the insurance claims may be taking longer to process, and to assuage customer concerns that might otherwise impact customer satisfaction scores based on long claim processing cycle times.

The user interface 138 may display dashboards, alerts, and/or other information associated with insight output 118 determined by the insight engine 114. For example, the user interface 138 may display information identifying the predictive data features 102 and/or corresponding target zones 106 determined based on the training of the machine learning model 108. The user interface 138 may also display metrics about current and/or past instances of the process based on evaluation of process data 116 by the insight engine 114, such as dashboards, charts, and/or other data indicating how many instances of the process have attributes with values that do and/or do not meet particular target zones 106. The user interface 138 may also display alerts associated with instances of the process, such as alerts about particular instances of the process that the feature comparer 136 indicates are at risk of not satisfying target zones 106.

Similarly, the report generator 140 can generate reports associated with insight output 118 determined by the insight engine 114. For example, the report generator 140 may generate reports indicating metrics about current and/or past instances of the process based on evaluation of process data 116 by the insight engine 114, such as charts and/or other data indicating how many instances of the process have attributes with values that do and/or do not meet particular target zones 106. Such reports may be printed, sent via electronic messages to designated recipients, and/or displayed via the user interface 138.

The insight engine 114 can determine metrics associated with different sets of instances of the process over time. For instance, if the process is insurance claim processing, the insight engine 114 may determine during a first month that 80% of insurance claims had values of predictive data features that were within target zones 106. However, the insight engine 114 may determine during a second month that only 65% of insurance claims had values of predictive data features that were within target zones 106. This month-to-month drop in the metrics can be indicated in a dashboard or report presented and/or output by the insight engine 114, such that any underlying issues that may be causing the drop in the metrics can be investigated and/or corrected.

The machine learning model 108 can also be re-trained occasionally or periodically, to re-evaluate which attributes are most predictive of outcome scores 104. For example, the machine learning model 108 can be re-trained quarterly on new training data sets, such as updated training data sets that reflect the most recent last ten quarters of historical data. Accordingly, at a first time, the machine learning model 108 may determine that a particular predictive data feature has the largest weight and most impacts outcome scores 104. However, at a second time when the machine learning model 108 is re-trained on a new or updated training data set, the machine learning model 108 may determine that a different predictive data feature now has the largest weight and most impacts outcome scores 104. Accordingly, the insight engine 114 can be updated and configured to use the latest predictive data features 102 and corresponding target zones 106 determined based on training of the machine learning model 108.

In some examples, the insight engine 114 and/or the machine learning model 108 can be used to predict outcome scores that are likely to be associated with current and/or past instances of the process, based on values of predictive data features 102 within the process data 116. As a non-limiting example, although a customer satisfaction score may not yet have been received from a customer associated with an insurance claim that is currently being processed, current values of predictive data features 102 associated with the current insurance claim, and weights associated with the predictive data features 102 determined by the training of the machine learning model 108, can be used to predict the customer satisfaction score that the customer would be likely to provide. The insight engine 114 may be configured to produce insight output 118 indicating such predicted customer satisfaction scores, or identify current insurance claims with the lowest predicted customer satisfactions scores, such that corrective actions can be taken to communicate with the customers and/or prioritize processing of the insurance claims such that predicted customer satisfaction scores associated with the insurance claims can be increased.

As discussed above, insight output 118 provided by the insight engine 114 can be used to determine when instances of the process have attributes that are outside corresponding target zones 106 and/or are at risk of going outside corresponding target zones 106, which may risk decreases in customer satisfaction scores or other outcome scores 104. The insight output 118 can thus be used to investigate underlying issues that may be leading to attributes of the instances of the process going outside target zones 106 or being close to going outside target zones 106, and/or to take proactive actions to avoid attributes of the instances of the process going outside target zones 106.

Overall, the system 100 can train the machine learning model 108 to identify predictive data features 102 and corresponding target zones 106 that may be associated with multiple types of data in the training data set 110, including types of data indicated by one or more of the operational data 120, the customer data 122, and the worker data 124. Accordingly, the machine learning model 108 can use different types of data from disparate data sources, about the same instances of the process, to determine which data features and/or combinations of data features are predictive data features 102 that most impact the outcome scores 104. The system 100 can also identify target zones 106 associated with one or more of the predictive data features 102, such that the insight engine 114 can determine whether other instances of the process have attributes that do or do not meet the target zones 106, and/or can determine when instances of the process have attributes that may be at risk of not meeting the target zones 106.

Conventional systems are generally not configured to evaluate different types of data, including different types of data obtained from different data sources, associated with the same instances of the process to determine which types of data from disparate data sources are most predictive of customer satisfaction scores or other outcome scores. For example, conventional systems generally do not consider the impact of worker data 124, including worker satisfaction scores, on customer satisfaction scores or other outcome scores, particularly in combination with other attributes of operational data 120 and/or customer data 122. Accordingly, the systems and methods described herein can more accurately determine, from broader data derived from disparate data sources, which types of data are predictive data features 102 that most impact outcome scores 104, as well as to more accurately determine corresponding target zones 106.

Although some examples discussed above relate to using the system 100 to identify predictive data features 102 that impact customer satisfaction scores or other outcome scores 104 associated with “claim journeys” of insurance claims during processing of the insurance claims by an insurance company, as well as determining target zones 106 associated with those predictive data features 102, in other examples the system 100 can be used to identify predictive data features 102 and corresponding target zones 106 that are associated with other types of processes and/or other types of outcome scores 104. For example, the outcome scores 104 may indicate customer satisfaction levels, worker satisfaction levels, third party satisfaction levels, customer retention levels, worker retention levels, and/or other metrics related to other types of processes. Such processes may involve interactions between customers and workers, such as interactions to pay bills, to add or change insurance coverage, to communicate about another type of product or service, and/or other types of interactions between customers and workers. Such processes may also, or alternately, involve other types of actions being taken by workers during performance of instances of the processes. In these examples, the operational data 120 can indicate information about how one or more types of interactions and/or actions were performed during instances of a process, and the customer data 122 and worker data 124 can respectively indicate information about customers and workers associated with the instances of the process. Accordingly, the machine learning model 108 can be trained to identify predictive data features 102 that impact outcome scores 104 associated with instances of types of processes other than insurance claim processing, and/or corresponding target zones 106 associated with those predictive data features 102.

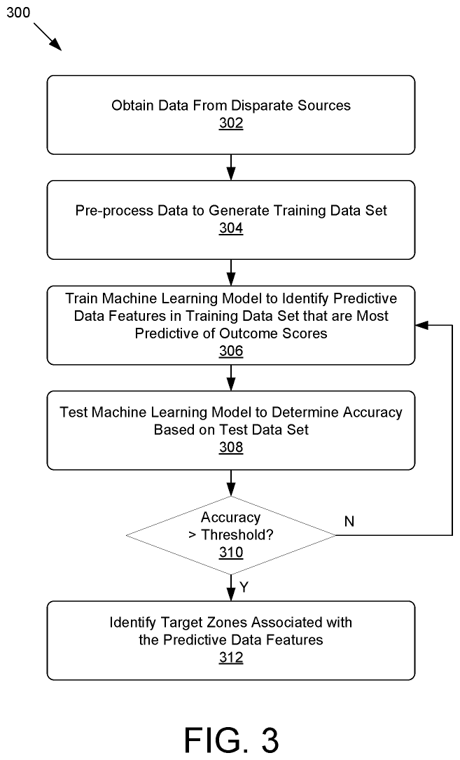

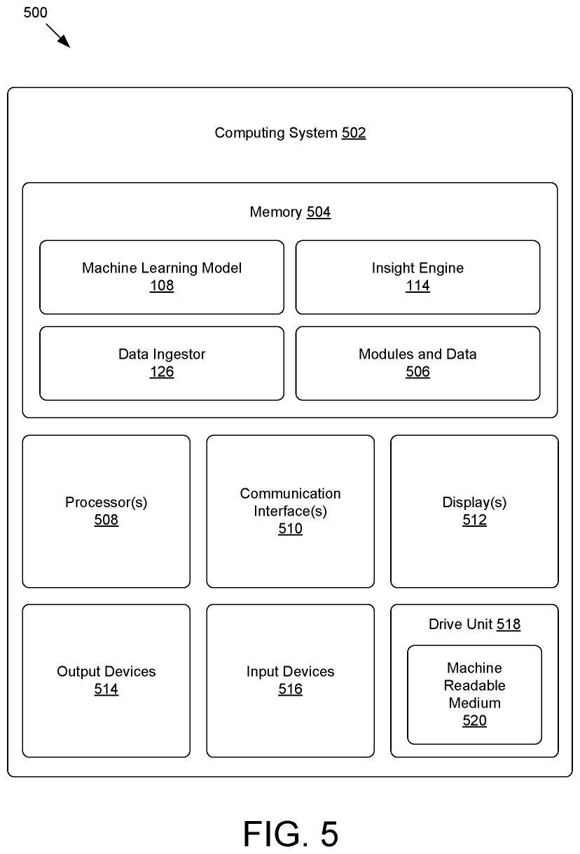

FIG. 3 shows a flowchart illustrating an example method 300 that can be used to train the machine learning model 108 and determine predictive data features 102 and corresponding target zones 106. The predictive data features 102 and corresponding target zones 106 may be associated with instances of a process, such as insurance claim processing by an insurance company, handling of customer contacts via a contact center, or another process performed by an entity. The method 300 shown in FIG. 3 can be performed by a computing system that is configured to execute the data ingestor 126 and/or the machine learning model 108. An example system architecture for such a computing system is described below with respect to FIG. 5.

At block 302, the computing system can use the data ingestor 126 to obtain data from disparate data sources. For example, the data ingestor 126 can obtain operational data 120 from the operational data repository 128, the customer data 122 from the customer data repository 130, the worker data 124 from the worker data repository 132, and/or the outcome scores 104 from the outcome score repository 134. The disparate data sources may be associated with different APIs and/or other access mechanisms, but the data ingestor 126 can be configured to use such different APIs and/or other access mechanisms to obtain data from the disparate data sources.

At block 304, the computing system can use the data ingestor 126 to pre-process the data obtained at block 302 to generate the training data set 110. Because the data obtained at block 302 can originate from different data sources, the data may be structured in different ways, may be provided in different data formats, and/or have other differences. However, at block 304, the data ingestor 126 can process the data to convert the data into a common format that can be used to train the machine learning model 108. The data ingestor 126 can also use identifiers and/or other data to determine data elements, within the different types of data received from the different data sources, that are related to the same instances of the process. For example, if the process is insurance claim processing, the data ingestor 126 can use claim identifiers and/or other data associated with insurance claims to determine data elements, within different types of data received from different data sources, that are related to the same insurance claims. The data ingestor 126 can accordingly generate the training data set 110 such that operational data 120, customer data 122, worker data 124, and/or outcome scores 104 associated with the same instances of the process are linked together in the training data set 110.

At block 306, the computing system can train the machine learning model 108, based on the training data set 110, to identify predictive data features 102 that are most predictive of outcome scores 104, such as customer satisfaction scores or other types of outcome scores 104, associated with previous instances of the process. As an example, if the process is insurance claim processing, customer satisfaction scores associated with previously-processed insurance claims can be used as targets for the training of the machine learning model 108. The computing system can thus use supervised machine learning processes to train the machine learning model 108 to determine which data points and/or corresponding types of data within the operational data 120, customer data 122, and/or worker data 124 associated with the previously-processed insurance claims are most predictive of the customer satisfaction scores associated with the previously-processed insurance claims.

At block 308, the computing system can test the machine learning model 108 trained at block 306, to determine the accuracy of the machine learning model 108 based on a test data set. The test data set may be a separate historical data set that contains the same types of information as the training data set 110, or can be a portion of the training data set 110 that was not used during block 306 to train the machine learning model 108. Accordingly, at block 308, the machine learning model 108 can use instances of the predictive data features 102 identified at block 306, and corresponding weights or other data determined during block 306, within the test data set to generate predicted outcome scores 104. The computing system can compare the predicted outcome scores 104 against actual target outcome scores 104 indicated by the test data set, to determine an accuracy level of the trained machine learning model.

At block 310, the computing system can determine whether the accuracy of the machine learning model 108 determined at block 308 exceeds a threshold accuracy level. If the accuracy of the machine learning model 108 does not exceed the threshold accuracy level (Block 310—No), the computing system can return to block 306 to continue training the machine learning model 108, for instance by continuing to adjust weights associated with data features and/or to consider different sets of data features. However, if the accuracy of the machine learning model 108 does exceed the threshold accuracy level (Block 310—Yes), the computing system can move to block 312.

At block 312, the computing system can identify target zones 106 associated with individual predictive data features 102 identified at block 306, and/or with combinations of predictive data features 102 identified at block 306. For example, the computing system can generate accumulated local effects plots showing changes in outcome scores 104 relative to changes in values of predictive data features 102, such that the computing system can determine values and/or ranges of the predictive data features 102 that are associated with outcome scores 104 within a target range. Such values and/or ranges can be used as target zones 106 associated with the corresponding predictive data features 102.

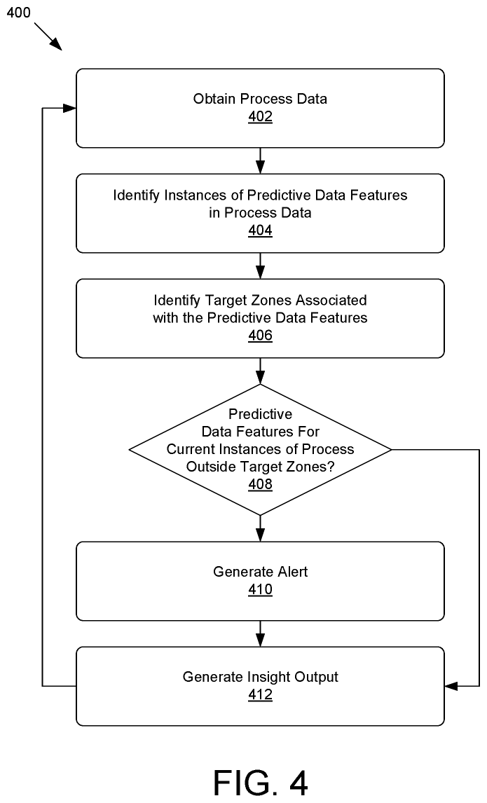

Based on the predictive data features 102 and corresponding target zones 106, the insight engine 114 can determine metrics, alerts, and/or other insight output 118 identifying particular instances of the process, and/or numbers of instances of the process that have attributes that are inside or outside target zones 106, or are at risk of going outside target zones 106, as discussed below with respect to FIG. 4. The method 300 shown in FIG. 3 can be repeated occasionally or periodically, for instance to obtain new or updated data at block 302 and to generate a new or updated training data set at block 304, such that the machine learning model 108 can be re-trained based on new or updated data. Accordingly, when the machine learning model 108 is re-trained, the re-training of the machine learning model 108 may identify new or different predictive data features 102 or assign different weights to different predictive data features 102. The re-training of the machine learning model 108 may also lead to new or different target zones 106 being identified in association with one or more predictive data features 102.

FIG. 4 shows a flowchart illustrating an example method 400 that can be used to generate insight output 118 associated with process data 116, based on predictive data features 102 and corresponding target zones 106 determined via training of the machine learning model 108. The predictive data features 102 and corresponding target zones 106 may be associated with instances of a process, such as insurance claim processing by an insurance company, handling of customer contacts via a contact center, or another process performed by an entity. The method 400 shown in FIG. 3 can be performed by a computing system that is configured to execute the insight engine 114. An example system architecture for such a computing system is described below with respect to FIG. 5.

At block 402, the computing system can obtain process data 116 about a set of instances of the process. The process data 116 may be associated with one or more instances of the process for which corresponding outcome scores 104 are not yet available and/or have not yet been received. For example, if the process is insurance claim processing, the process data 116 may be associated with a set of one or more previously-processed insurance claims, and/or one or more insurance claims that are currently being processed, for which corresponding customers have not yet provided customer satisfaction scores via customer surveys or other methods.

In some examples, the computing system can obtain the process data 116 from the data ingestor 126, or use the data ingestor 126 to obtain the process data 116 from disparate data sources. For example, the data ingestor 126 can obtain operational data 120 from the operational data repository 128, the customer data 122 from the customer data repository 130, and/or the worker data 124 from the worker data repository 132. As discussed above, the disparate data sources may be associated with different APIs and/or other access mechanisms, but the data ingestor 126 can be configured to use such different APIs and/or other access mechanisms to obtain data from the disparate data sources. The data ingestor 126 may also pre-process the retrieved data to convert the process data 116 into a common format, identify data elements within data received from one or more sources that are relevant to the same individual instances of the process, and/or otherwise prepare the process data 116 to be analyzed via the insight engine 114.

At block 404, the computing system can identify instances of predictive data features 102 within the process data 116. The predictive data features 102 can have been determined via training of the machine learning model 108, for example as discussed above with respect to FIG. 3. The predictive data features 102 can be attributes or types of data that the training of the machine learning model 108 indicates are key drivers of, and/or most predictive of, outcome scores 104. Accordingly, although the process data 116 obtained at block 402 is not yet associated with outcome scores 104, the computing system can identify instances of attributes or types of data, associated with the predictive data features 102 that are likeliest to impact outcome scores 104, within the process data 116.

At block 406, the computing system can identify target zones 106 associated with individual predictive data features 102 and/or combinations of predictive data features 102. The target zones 106 can have been determined based on the training of the machine learning model 108, for example as discussed above with respect to FIG. 3. The target zones 106 can be values, or ranges of values, of one or more predictive data features 102 that are likely to be associated with outcome scores 104 that are within a desired target range.

At block 408, the computing system can determine whether current instances of the process have values of one or more predictive data features 102 that are outside of corresponding target zones 106 identified at block 406. As an example, if the process is insurance claim processing and a target zone is a number of incoming calls that is two or fewer, the computing system can use process data 116 to determine whether one or more insurance claims that are currently being processed have had more than two incoming calls and are thus outside that target zone. As discussed above, target zones 106 may also be associated with combinations of different predictive data features 102. Accordingly, the computing system can determine whether values of different predictive data features 102, associated with individual instances of the process, are inside or outside corresponding target zones 106 associated with combinations of those predictive data features 102.

If the computing system determines that any current instances of the process are associated with values of one or more predictive data features 102 that are outside of corresponding target zones 106 (Block 408—Yes), the computing system may generate and/or output an alert at block 410. The alert may be provided in a report generated by the report generator 140, and/or displayed via the user interface 138. The alert can identify the current instances of the process that have values of predictive data features 102 that are outside corresponding target zones 106, and thereby alert users and/or other systems that those instances of the process may be at risk of being associated with customer satisfactions scores or other outcome scores 104 that are outside a desired or target range. The alert may prompt workers or other entities to perform one or more actions to investigate and/or address underlying issues that may be causing values to be outside the target zones 106, take actions to reassign and/or expedite performance of the instances of the process, take actions to reach out to corresponding customers associated with the instances of the process, and/or take any other actions.

In some examples, at block 408 the computing system may also use the process data 116 to determine whether any current instances of the process have values of attributes that are currently meeting corresponding target zones 106, but that are at or near to the boundaries of corresponding target zones 106 and may thus be at risk of going outside the target zones 106. In these examples, if the computing system determines that any current instance of the process are at risk of going outside the target zones 106, the computing system may also generate a corresponding alert at block 410 so that preemptive actions can be taken to reduce the likelihood of the instances of the process going outside the target zones 106.

At block 412, the computing system can also, or alternately, generate other types of insight output 118 based on whether instances of the predictive data features 102 have values that are inside or outside of corresponding target zones 106. For example, if the process is insurance claim processing, the report generator 140 can generate reports indicating how many insurance claims associated with the process data 116 have values that are inside and/or outside corresponding target zones 106. As another example, if the process is insurance claim processing, the user interface 138 can display dashboards, graphs, and/or other user interface elements indicating metrics associated with how many insurance claims have values of predictive data features 102 that are inside and/or outside corresponding target zones 106.

The method shown in FIG. 4 can be repeated continuously, occasionally, or periodically, for instance to evaluate new or updated process data 116 associated with new or different sets of instances of the process. The insight output 118 generated at block 412 can also indicate trends in the insight output 118 over periods of time. For example, the insight output 118 presented via the user interface and/or generated reports can indicate changes in how many instances of the process met and/or did not meet target zones 106 during different weeks, months, or other periods of time.

FIG. 5 shows an example system architecture 500 for a computing system 502 that can execute one or more elements of the system 100 described herein. For example, the computing system 502 may execute one or more portions of the system 100, such as the machine learning model 108, the insight engine 114, and/or the data ingestor 126. The computing system 502 can include one or more servers, computers, or other types of computing devices. Individual computing devices of the computing system 502 may have the system architecture 500 shown in FIG. 5, or a similar system architecture.

In some examples, elements of the system 100 can be distributed among, and/or be executed by, multiple computing systems or devices similar to the computing system 502 shown in FIG. 5. As an example, the machine learning model 108 may be executed by a different computing system than the insight engine 114. As another example, the data ingestor 126 may be executed by a different computing system than the machine learning model 108.

The computing system 502 may, in some examples, be part of a cloud computing environment or other computing environment that hosts and/or executes one or more elements of the system 100. For instance, a cloud computing environment may include multiple servers or other computing devices that can host elements of the system 100. In some examples, the servers or other computing devices of such a cloud computing environment may use one or more virtual machines, containers, and/or other systems to execute one or more elements of the system 100.

The computing system 502 can include memory 504. In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 502. Any such non-transitory computer-readable media may be part of the computing system 502.

The memory 504 can store one or more types of data, computer-executable instructions associated with software elements, firmware elements, or other executable elements, and/or other information. For example, the memory 504 can store computer-executable instructions and data associated with the machine learning model 108, the insight engine 114, and/or the data ingestor 126. In some examples, the memory 504 can also store copies of data used by, and/or generated by the machine learning model 108, the insight engine 114, and/or the data ingestor 126, such as the training data set 110, the model training output 112, the process data 116, and/or the insight output 118.

The memory 504 can also store other modules and data 506, such as other modules and/or data that can be utilized by the computing system 502 to perform or enable performing any action taken by the computing system 502. Such other modules and data 506 can include a platform, operating system, and/or applications, as well as data utilized by the platform, operating system, and/or applications.

The computing system 502 can also have processor(s) 508, communication interfaces 510, a display 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with common types of volatile (RAM) and/or nonvolatile (ROM) memory.

The communication interfaces 510 can include transceivers, modems, interfaces, antennas, telephone connections, and/or other components that can transmit and/or receive data over networks, telephone lines, or other connections. In some examples, the communication interfaces 510 can be used by the data ingestor 126 to access and/or retrieve data from one or more data sources, such as the outcome scores 104, the operational data 120, the customer data 122, and/or the worker data 124.

The display 512 can be a liquid crystal display, or any other type of display commonly used in computing devices. For example, a display 512 may be a touch-sensitive display screen, and can then also act as an input device or keypad, such as for providing a soft-key keyboard, navigation buttons, or any other type of input.

The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing system 502. The memory 504 and the processor(s) 508 also can constitute machine readable media 520.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
generating, by a computing system, and based on data retrieved from a plurality of data sources, a training data set comprising:
process data associated with performance of instances of a process; and
outcome scores associated with the instances of the process;
training, by the computing system, and based on the training data set, a machine learning model to identify predictive data features, indicated by the process data, that are predictive of the outcome scores; and
determining, by the computing system, target zones associated with the predictive data features, wherein the target zones indicate values of the predictive data features that are associated with a target range of the outcome scores.

2. The computer-implemented method of claim 1, wherein the process data includes one or more of:
operational data associated with the instances of the process,
customer data associated with customers associated with the instances of the process, or
worker data associated with workers that performed the instances of the process.

3. The computer-implemented method of claim 2, wherein the operational data, the customer data, the worker data, and the outcome scores are stored in different formats by the plurality of data sources, and generating the training data set comprises:
obtaining the operational data, the customer data, the worker data, and the outcome scores from the plurality of data sources;
converting the operational data, the customer data, the worker data, and the outcome scores to a common data format;
identifying data elements of the operational data, the customer data, the worker data, and the outcome scores that are associated with same instances of the process; and
linking the data elements, in the training data set, that are associated with the same instances.

4. The computer-implemented method of claim 2, wherein the worker data comprises worker satisfaction scores based on answers to worker surveys provided by the workers.

5. The computer-implemented method of claim 1, wherein the outcome scores comprise customer satisfaction scores indicating subjective satisfaction levels of customers associated with the instances of the process.

6. The computer-implemented method of claim 1, further comprising:
identifying, by the computing system, instances of the predictive data features within second process data associated with second instances of the process;
determining, by the computing system, whether the instances of the predictive data features are associated with second values that are within the target zones; and
generating, by the computing system, insight output based on determining whether the instances of the predictive data features are associated with the second values that are within the target zones.

7. The computer-implemented method of claim 6, wherein the insight output identifies one or more particular instances of the process, of the second instances of the process, that are associated with third values that are outside the target zones.

8. The computer-implemented method of claim 6, wherein:
the second instances of the process are current instances of the process, and
the insight output identifies one or more particular instances of the process, from among the current instances of the process, that are associated with instances of the second values that are:
currently inside the target zones, and
are projected to move outside the target zones within a future period of time.

9. The computer-implemented method of claim 1, wherein:
the training of the machine learning model identifies a combination of the predictive data features that is predictive of the outcome scores; and
the target zones are associated with combinations of values, associated with the combination of the predictive data features, that are associated with the target range of the outcome scores.

10. The computer-implemented method of claim 9, wherein:
the process data includes worker data associated with workers that performed the instances of the process, and
the combination of the predictive data features includes at least one predictive data feature associated with the worker data.

11. A computing system, comprising:
one or more processors, and
memory storing computer-executable instructions that, when executed by the one or more processors, cause the one or more processors to:
generate a training data set that comprises:
process data associated with performance of instances of a process; and
outcome scores associated with the instances of the process;
train a machine learning model, based on the training data set, to identify predictive data features, indicated by the process data, that are predictive of the outcome scores; and
determine target zones associated with the predictive data features, wherein the target zones indicate values of the predictive data features that are associated with a target range of the outcome scores.

12. The computing system of claim 11, wherein the process data includes one or more of:
operational data associated with the instances of the process,
customer data associated with customers associated with the instances of the process, or
worker data associated with workers that performed the instances of the process.

13. The computing system of claim 11, wherein the outcome scores comprise one or more of:
customer satisfaction scores associated with customers associated with the instances of the process,
customer retention scores associated with the customers,
worker satisfaction scores associated with workers that performed the instances of the process;
worker retention scores associated with the workers, or
third party satisfaction scores associated with third parties associated with the instances of the process.

14. The computing system of claim 11, wherein the computer-executable instructions further cause the one or more processors to:
identify instances of the predictive data features within second process data associated with second instances of the process;
determine whether the instances of the predictive data features are associated with second values that are within the target zones; and
generate insight output based on determining whether the instances of the predictive data features are associated with the second values that are within the target zones.

15. The computing system of claim 11, wherein the training data set is generated by:
obtaining one or more data types and the outcome scores from a plurality of disparate data sources;
identifying data elements, within the one or more data types and the outcome scores, that are associated with same instances of the process; and
linking the data elements, in the training data set, that are associated with the same instances of the process.

16. One or more non-transitory computer-readable media storing computer-executable instructions that, when executed by one or more processors of a computing system, cause the computing system to:
generate a training data set that comprises:
first process data associated with performance of historical instances of a process; and
outcome scores associated with the historical instances of the process;
train a machine learning model, based on the training data set, to identify predictive data features, indicated by the first process data, that are predictive of the outcome scores;
determine target zones associated with the predictive data features, wherein the target zones indicate values of the predictive data features that are associated with a target range of the outcome scores;
identify instances of the predictive data features within second process data associated with performance of second instances of the process;
determine whether the instances of the predictive data features are associated with second values that are within the target zones; and
generate insight output based on determining whether the instances of the predictive data features are associated with the second values that are within the target zones.

17. The one or more non-transitory computer-readable media of claim 16, wherein the first process data includes worker data associated with workers that performed the historical instances of the process.

18. The one or more non-transitory computer-readable media of claim 17, wherein the first process data further includes at least one of:
operational data associated with the performance of the historical instances of the process, or
customer data associated with customers associated with the historical instances of the process.

19. The one or more non-transitory computer-readable media of claim 16, wherein the training data set is generated by:
obtaining one or more data types and the outcome scores from a plurality of disparate data sources;
identifying data elements, within the one or more data types and the outcome scores, that are associated with same instances of the process; and
linking the data elements, in the training data set, that are associated with the same instances of the process.

20. The one or more non-transitory computer-readable media of claim 16, wherein the second instances of the process comprise current instances of the process.
